(19) United States
(12) Patent Application Publication
(10) Pub. No.: US 2014/0268336 A1
(43) Pub. Date: Sep. 18, 2014

(54) VIRTUAL IMAGE DISPLAY APPARATUS

(71) Applicant: Seiko Epson Corporation, Tokyo (JP)

(72) Inventor: Noriaki Hiraide, Azumino-shi (JP)

(73) Assignee: Seiko Epson Corporation, Tokyo (JP)

(21) Appl. No.: 14/179,718

(22) Filed: Feb. 13, 2014

(30) Foreign Application Priority Data
Mar. 13, 2013 (JP) 2013-050109

(51) Int. Cl. G02B 27/00; G02B 27/01

(52) U.S. Cl. CPC G02B 27/0006; G02B 27/0172
USPC 359/507; 359/633

(57) ABSTRACT

A virtual image display apparatus (head mounted display) that is worn around a head of a viewer and displays a virtual image includes a projection optical section that projects light that forms an image, a lens barrel that accommodates the projection optical section, a light-transmissive light guide member that causes the light from the projection optical section to be internally reflected and guided to an eye of the viewer to allow the viewer to visually recognize the image as a virtual image, and a blocking section that blocks a gap created between the light guide member and the lens barrel.

### BACKGROUND

1. Technical Field

The present invention relates to a virtual image display apparatus.

2. Related Art

There is a known virtual image display apparatus, such as an HMD (head mounted display) worn around the head a viewer (see JP-A-2012-163639).

The HMD described in JP-A-2012-163639 includes an image formation section provided on each of the right and left sides of the viewer, a cover that accommodates each of the image formation sections, and a light guide plate that guides image light formed by each of the image formation sections to the corresponding one of the right and left eyes of the viewer. Among the components described above, each of the image formation sections includes a display device, a projection optical section, and a lens barrel that accommodates the projection optical section, and the projection optical section projects image light formed by the display device toward the light guide plate. The light guide plate causes the image light having entered the light guide plate to travel based on reflection and then causes the image light to be reflected off a half-silvered mirror formed on an end surface of the light guide plate so that the image light is guided to the corresponding one of the eyes of the viewer.

The HMD is configured as a see-through-type HMD, and each of the light guide plates not only causes image light incident thereon to travel based on internal total reflection and then causes the image light to be reflected toward the corresponding one of the eyes of the viewer but also causes outside light incident from the outside to pass through to the eye.

In this process, to allow the image light projected from each of the projection optical sections to be incident on the corresponding light guide plate, it is conceivable to dispose the light guide plate in a position close to the lens barrel, which accommodates the projection optical section. When the lens barrel accidentally comes into contact with the light guide plate, however, the light guide plate may undesirably be damaged. To prevent any damage on the light guide plate, it is conceivable to provide a gap between the light guide plate and the lens barrel. In this case, however, dust undesirably tends to enter the lens barrel through the gap.

Further, since the light guide plate is disposed in a position according to the eye of the viewer and exposed to the outside, dust (including sebum and other substance) tends to adhere to the light guide plate. To remove the dust, wiping the light guide plate with a cloth or any other wiping material tends to cause dust pushed into the gap to enter the lens barrel.

When dust enters the lens barrel, it is difficult to remove the dust and a shadow of the dust may undesirably be recognized in some cases.

### SUMMARY

An advantage of some aspects of the invention is to provide a virtual image display apparatus that prevents dust from entering the virtual image display apparatus.

An aspect of the invention is directed to a virtual image display apparatus that is worn around a head of a viewer and displays a virtual image, the apparatus including a projection optical section that projects light that forms an image, a lens barrel that accommodates the projection optical section, a light-transmissive light guide member that causes the light from the projection optical section to be internally reflected and guided to an eye of the viewer to allow the viewer to visually recognize the image as a virtual image, and a blocking section that blocks a gap created between the light guide member and the lens barrel.

The virtual image display apparatus may be configured to allow the viewer to visually recognize only light that form an image or allow the viewer to visually recognize both the light and outside light simultaneously.

According to the aspect of the invention, the blocking section blocks the gap created between the light guide member and the lens barrel. The blocking section therefore prevents dust from entering the lens barrel through the gap and hence prevents dust from adhering to the projection optical section accommodated in the lens barrel, whereby an image visually recognized based on the projected light will not be degraded and maintenance operation of removing dust from the interior of the lens barrel can be omitted.

In the aspect of the invention, it is preferable that the light guide member has a light incident area on which the light from the projection optical section is incident, a first reflection area that is inclined to a central axis of the light incident on the light incident area and reflects the incident light, and a second reflection area on which the light reflected off the first reflection area is incident and which reflects the incident light, and the blocking section is so disposed that an air layer is created between the blocking section and the second reflection area and the second reflection area is covered.

When dust having adhered to the second reflection area is present, a shadow of the dust is possibly visually recognized by the viewer. To avoid the situation, in the aspect described above, covering the second reflection area with the blocking section prevents dust from adhering to the second reflection area, whereby no shadow of dust is visually recognized.

Further, since the blocking section is so disposed that an air layer is created between the blocking section and the second reflection area, providing the blocking section will not change reflection characteristics of the second reflection area. The light having entered the light guide member is therefore allowed to be reflected appropriately and then guided to the eye of the viewer.

In the aspect of the invention, it is preferable that the light guide member further has a third reflection area that faces the second reflection area and reflects the light reflected off the second reflection area, a fourth reflection area that faces the third reflection area and reflects the light reflected off the third reflection area, a fifth reflection area that reflects the light incident from the fourth reflection area toward the eye of the viewer, and a light exiting area through which the light reflected off the fifth reflection area exits toward the eye of the viewer, and an in-focus portion where the light that forms the image is brought into focus is set in the light guide member between the second reflection area and the third reflection area.

According to this configuration, since the in-focus portion, where the light that forms the image is brought into focus, is set between the second reflection area and the third reflection area, the light having passed through the in-focus portion travels through the light guide member with the transmission range increasing. The light is then incident on the eye of the viewer via the third reflection area, the fourth reflection area, the fifth reflection area and the light exiting area, whereby the light can travel along a long optical path. The image visually recognized based on the light can therefore be enlarged.

On the other hand, since the in-focus portion described above is set between the second reflection area and the third reflection area, any dust having adhered to the second reflection area is likely to not only cause the viewer to visually recognize a shadow of the dust but also change reflection characteristics of the second reflection area. To avoid the situation, providing the blocking section prevents dust from adhering to the second reflection area and hence reliably prevents a shadow of dust from being visually recognized but allows the light incident on the second reflection area to be appropriately reflected.

In the aspect of the invention, it is preferable that the blocking section has a contact portion that comes into contact with a portion around the second reflection area in the light guide member and a recess that forms the air layer between the blocking section and the second reflection area when the contact portion comes into contact with the portion around the second reflection area.

The contact portion is not necessarily in contact with the entire portion around the second reflection area.

According to this configuration, in the state in which the contact portion is in contact with the portion around the second reflection area, the recess of the blocking section creates the air layer between the blocking section and the second reflection area. The blocking section therefore reliably prevents reflection characteristics of the second reflection area from changing because the blocking section is not in contact with the second reflection area. Therefore, the light incident on the second reflection area can be appropriately reflected, and hence the light can be reliably guided to the eye of the viewer.

In the aspect of the invention, it is preferable that the light guide member has a pair of intersecting surfaces that intersect the second reflection area, the intersecting surfaces located in positions that sandwich the second reflection area in a direction substantially perpendicular to a direction along the second reflection area when viewed from the viewer's side, and the blocking section has a sandwiching portion that comes into contact with the pair of intersecting surfaces to sandwich the light guide member.

According to this configuration, the sandwiching portion, which sandwiches the pair of intersecting surfaces that sandwich the second reflection area, allows the blocking section to be attached to the light guide member in a stable manner with the blocking section not in contact with the second reflection area.

In the aspect of the invention, it is preferable that the virtual image display apparatus further includes a first frame that supports the lens barrel and the light guide member and a second frame that is attached to the first frame and located on the viewer's side with respect to the light guide member, and the second frame includes an optical part that is provided in accordance with the eye of the viewer and has a predetermined optical characteristic and a rim that holds the optical part, and the rim comes into contact with the blocking section.

According to this configuration, the second frame, which includes the optical part having a predetermined optical characteristic, can be attached to the first frame at a position located on the viewer's side with respect to the light guide member. In this configuration, when the optical part is a lens for vision correction, even a viewer having poor vision can visually recognize an image in a preferable manner. When the optical part is a filter that prevents transmission of color light of a predetermined wavelength, the color tone of a visually recognized image can be corrected. When the optical part is a filter that prevents transmission of blue light, which is believed to have relatively strong energy, an effect of blue light on the eye of the viewer can be reduced.

Further, since the rim, which forms the second frame and holds the optical part, comes into contact with the blocking section, the rim will not come into contact with the light guide member to damage the light guide member.

In the aspect described above, it is preferable that the blocking section has elasticity and is detachably attached to the light guide member.

An example of an elastic material may be silicon rubber.

According to this configuration, since the blocking section has elasticity, the blocking section can be in intimate contact with the light guide member. The blocking section can therefore reliably prevent dust from entering the apparatus.

Further, since the blocking section can be detachably attached to the light guide member, the blocking section can be exchanged when dust adheres to the blocking section or the blocking section otherwise becomes dirty. The virtual image display apparatus can therefore be readily maintained clean.

In the aspect of the invention, it is preferable that the light guide member has a shape curved along the head of the viewer.

When the light guide member does not have a shape that follows the head of the viewer but has, for example, a flat-plate-like shape, the center of gravity of the light guide member tends to be separate from the viewer, resulting in discomfort of the viewer who wears the virtual image display apparatus. To avoid the situation, in the configuration described above, the light guide member has a shape curved along the head of the viewer, whereby the center of gravity of the light guide member approaches the viewer, and hence the viewer can comfortably and stably wear the virtual image display apparatus.

On the other hand, when the light guide member has the curved shape described above, it is difficult to control the gap between the light guide member and the lens barrel, and the size of the gap may, for example, increase, encouraging dust to enter the gap. Even in such a case, providing the blocking section prevents dust from entering the apparatus through the gap, whereby the advantageous effects described above provided by the curved shape of the light guide member can be preferably provided.

### BRIEF DESCRIPTION OF THE DRAWINGS

The invention will be described with reference to the accompanying drawings, wherein like numbers reference like elements.

FIG. 1 is a perspective views showing a head mounted display according to an embodiment of the invention.

FIG. 2 is another perspective view showing the head mounted display in the embodiment.

FIG. 3 is a perspective view showing the head mounted display in the embodiment to which an auxiliary frame is attached.

FIG. 4 is a perspective view showing the head mounted display in the embodiment from which cover members are removed.

FIG. 5 is another perspective view showing the head mounted display in the embodiment from which cover members are removed.

FIG. 6 is an exploded perspective view showing the head mounted display in the embodiment from which cover members are removed.

FIG. 7 is a lateral cross-sectional view showing an optical unit in the embodiment.

FIG. 8 is a perspective view showing a light guide member in the embodiment.

FIG. 9 is another perspective view showing the light guide member in the embodiment.

FIG. 10 is a lateral cross-sectional view showing the light guide member in the embodiment.

FIG. 11 shows the optical path of image light in the embodiment.

FIG. 12 is a perspective view showing the light guide member and a dustproof cover in the embodiment.

FIG. 13 is a perspective view of the dustproof cover in the embodiment viewed from the side where the light guide member is present.

FIG. 14 is a lateral cross-sectional view showing an optical section in the embodiment.

### DESCRIPTION OF EXEMPLARY EMBODIMENTS

An embodiment of the invention will be described below with reference to the drawings.

### Schematic Configuration of Head Mounted Display

FIGS. 1 and 2 are perspective views of a head mounted display 1 according to the present embodiment viewed from the front and the rear. In other words, FIG. 1 is a perspective view of the head mounted display 1 viewed from the side opposite to the viewer's side, and FIG. 2 is a perspective view of the head mounted display 1 viewed from the viewer's side.

The head mounted display (hereinafter abbreviated to HMD in some cases) 1 according to the present embodiment is a virtual image display apparatus worn around the head of the viewer for use as shown in FIGS. 1 and 2 and a see-through-type HMD that not only causes image light formed in accordance with image information (image forming light) to be incident on the eyes of the viewer to allow the viewer to visually recognize an image formed by the image light as a virtual image but also allows outside light to pass through the HMD to allow the viewer to observe an outside light image. The thus configured HMD 1 includes a frame 2 and two optical sections 3 attached to the frame 2.

### Configuration of Frame

The frame 2 corresponds to a first frame according to an embodiment of the invention and has a configuration like a frame of glasses. The frame 2 include a U-shaped portion 21, which extends along the forehead and the right and left temples of the viewer, a pair of arms 22, which are attached in a bendable manner to opposite ends of the U-shaped portion 21, and a protector 23 and a nose pad 24, which are attached to the U-shaped portion 21.

The U-shaped portion 21 has a substantially U-like shape having a front portion 211, which extends along the forehead of the viewer when the viewer wears the HMD 1, and a pair of temple portions 212, which extend in the same direction from opposite ends of the front portion 211.

In the thus configured U-shaped portion 21, the pair of temple portions 212 are disposed in positions corresponding to the right and left temples of the viewer. The thus configured temple portions 212 is formed of a temple portion 212R, which is located on the right when viewed from the viewer's side and to which a cover member 4 that covers an optical section 3R for the right eye is attached, and a temple portion 212L, which is located on the left when viewed from the viewer's side and to which another cover member 4 that covers an optical section 3L for the left eye is attached.

The arms 22 (reference character 22R denotes the arm located on the right of the viewer, and reference character 22L denotes the arm located on the left of the viewer) are attached in an inwardly bendable manner via hinges 213 to the corresponding temple portions 212, specifically, the ends thereof facing away from the front portion 211. The arms 22 press the head of the viewer, specifically, the ears of the viewer, whereby the HMD 1 is securely attached to the head. When the viewer does not use the HMD 1, the viewer can fold up the arms 22 by bending them inward with respect to the temple portions 212, whereas when the viewer uses the HMD 1, the viewer can place the arms 22 on the ears of the viewer by stretching them in such a way that they are parallel to the temple portions 212.

The protector 23 is a member that fixes light guide members 6, which will be described later, in the optical sections 3L and 3R to the front portion 211 and has a shape like an under rim of glasses. The protector 23 can be attached to the front portion 211 from below.

The nose pad 24 has an inverted V-like shape when viewed from the viewer's side and is disposed in a position corresponding to a bridge of protector 23. The nose pad 24 sandwiches the nose of the viewer from right and left to prevent the HMD 1 worn on the viewer from shifting rightward, leftward, or downward.

FIG. 3 is a perspective view showing the HMD 1 to which an auxiliary frame 25 is attached.

The auxiliary frame 25 for a viewer who needs vision correction can be attached to the front portion 211, as shown in FIG. 3. The auxiliary frame 25 corresponds to a second frame according to an embodiment of the invention and includes right and left lenses 251R, 251L for vision correction, rims 252R and 252L, which surround the respective lenses 251R and 251L, and a bridge 253, which connects the rims 252R and 252L to each other. Among the components described above, the bridge 253 has, although not shown in detail, an attachment portion via which the auxiliary frame 25 is attached to the front portion 211.

When the thus configured auxiliary frame 25 is attached to the front portion 211, end portions 2521, which face away from each other, of the rims 252R and 252L come into contact with dustproof covers 7, which will be described later, provided on the right and left sides, specifically, viewer-side surfaces 7A of the corresponding dustproof covers 7.

### Configuration of Optical Section

Each of the optical sections 3 (3R, 3L) forms an image according to inputted image information and allows the viewer to visually recognize the image as a virtual image. Each of the optical sections 3R and 3L includes a cover member 4, an optical unit 5 (not shown in FIGS. 1 to 3), alight guide member 6, which is disposed in a position according to the corresponding eye of the viewer, and a dustproof cover 7 (FIGS. 2 and 3), as shown in FIGS. 1 to 3.

In the following sections, the optical section 3L will be described, and the optical section 3R, which has a structure mirror symmetric to the structure of the optical section 3L, also has the same configuration, although horizontally reversed, as the configuration of the optical section 3L.

### Configuration of Cover Member

The cover members 4, which cover the optical sections 3R and 3L, are attached to the right and left temple portions 212R, 212L and accommodate the optical units 5, as shown in FIGS. 1 to 3. Each of the cover members 4 has a first cover 41 and a second cover 42, which are so attached to the corresponding temple portion 212 that they sandwich the temple portion.

The first cover 41 is attached to the outer side (side facing away from viewer) of the temple portion 212. The first cover 41 has a substantially L-like shape in a plan view that follows the contour from the end of the front portion 211 described above to the temple portion 212, specifically, the end thereof facing the arm 22. In detail, the first cover 41 is so provided that it covers, from the front, part of the light guide member 6, which is disposed in a position according to the eye of the viewer, specifically, an end portion thereof facing the temple portion 212 (fifth surface S5, which will be described later).

The second cover 42 has a substantially L-like shape in a plan view that extends along the end of the front portion 211 and the temple portion 212 and is disposed inside the temple portion 212 (on viewer's side) and combined with the first cover 41. A recess 421, into which an end portion of the dustproof cover 7, which will be described later, is fit, is formed in the second cover 42, specifically, an end portion thereof facing the front portion 211, as shown in FIG. 2.

The configuration of the dustproof covers 7 and how each of the dustproof covers 7 is fit into the corresponding recess 421 will be described later in detail.

### Configuration of Optical Unit

FIGS. 4 and 5 are front and rear perspective views of the HMD 1 from which the cover members 4 are removed. FIG. 6 is an exploded perspective view showing the HMD 1 in the no-cover-member state. In FIGS. 4 to 6, part of the configuration is omitted.

The optical unit 5 in each of the optical sections 3R and 3L forms image light according to inputted image information and outputs the image light to the corresponding light guide member 6. The optical unit 5 includes an image formation section 51, a projection optical section 52 (see FIG. 7), a lens barrel 53, and a drive section 54 (see FIG. 7), which drives the image formation section 51, as shown in FIGS. 4 to 6.

### Configuration of Image Formation Section

The image formation section 51 forms the image light described above. The image formation section 51 includes a light source portion 511, a light modulation portion 512, and a holding member 513, which holds the light source portion 511 and the light modulation portion 512 as an integrated unit.

The light source portion 511 emits light toward the light modulation portion 512 to illuminate an image formation area of the light modulation portion 512. As the light source portion 511, a configuration having an LED (light emitting diode) or any other solid-state light source is employed in the present embodiment, and a flexible printed circuit board FPC1, which is connected to the drive section 54, extends out of the light source portion 511.

The light modulation portion 512 modulates the light incident from the light source portion 511 in accordance with an image signal inputted from a drive circuit. The light modulation portion 512 is formed of a liquid crystal panel including a polarizer, and a flexible printed circuit board FPC2, through which the image signal is inputted to the liquid crystal panel, is connected to the drive section 54.

The holding member 513 has a substantially U-like shape in a side view and holds the light source portion 511 and the light modulation portion 512. The holding member 513 has a pair of protrusions 5131, which protrude toward the lens barrel 53 and are formed on the upper and lower sides of the holding member 513. Each of the pairs of the protrusions 5131 sandwiches a support portion 532 formed in the lens barrel 53, whereby the holding member 513 is integrated with the lens barrel 53.

### Configuration of Projection Optical Section

FIG. 7 is a lateral cross-sectional view showing one of the optical sections 3 (3L).

The projection optical section 52 projects the image light incident from the image formation section 51 toward the light guide member 6, as shown in FIG. 7. The projection optical section 52 is formed of a plurality of lenses accommodated and arranged in the lens barrel 53, specifically, formed of three lenses 521 to 523 in the present embodiment. The number and characteristics of lenses can be set as appropriate.

### Configuration of Lens Barrel

The lens barrel 53 is an enclosure made of a synthetic resin and not only accommodates the projection optical section 52 formed of the lenses 521 to 523 described above but also supports the image formation section 51. The lens barrel 53 is fixed to the corresponding temple portion 212 with a screw SC2, as shown in FIG. 6. The thus configured lens barrel 53 has a through hole 531 formed therein. The through hole 531 is open toward both the image formation section 51 and the light guide member 6 and guides the image light incident from the image formation section 51 to the light guide member 6 via the projection optical section 52 described above.

In addition, the lens barrel 53 includes the support portions 532, which support the image formation section 51, and an opening portion 533, which is connected to the through hole 531 and into which an end portion of the light guide member 6 is inserted. In the thus configured lens barrel 53, each of the support portions 532 is sandwiched between the corresponding pair of protrusions 5131 described above, whereby the holding member 513 and hence the image formation section 51 are attached to the lens barrel 53.

The opening portion 533 has a substantially rectangular shape, and one end portion of the light guide member 6, specifically, the end portion facing away from the other light guide member 6 (of the two light guide members 6, a left end portion of the left light guide member 6L and a right end portion of the right light guide member 6R) is inserted into the opening portion 533. A first area S41, which is a light incident surface on which image light is incident and will be described later in detail, is located at the end portion of the light guide member 6, and when the end portion is inserted into the opening portion 533, the lens 523, which forms the projection optical section 52, faces the first area S41.

The inner surface of one of the edges that form the rectangular opening portion 533, specifically, the inner surface of the outer edge (on the side facing away from the viewer but facing first cover 41) is in contact with a bonding surface 62, which connects a fourth surface S4 and a fifth surface S5, which will be described later, of the light guide member 6, as shown in FIG. 7. Further, the inner surfaces of the upper and lower edges of the opening portion 533 are in contact with protrusions 611 and 612, which will be described later, of the light guide member 6.

On the other hand, one of the edges that form the opening portion 533, specifically, the inner edge (facing viewer and second cover 42) has an extending portion 534 formed thereon, which extends along the fourth surface S4, which will be described later, of the light guide member 6 and further extends out of the opening portion 533. The extending portion 534 is not in contact with the fourth surface S4 but is set apart from the fourth surface S4. The dustproof cover 7, which blocks a gap G between the extending portion 534 and the fourth surface S4, is provided on the light guide member 6 and the second cover 42. The configuration of the dustproof cover 7 will be described later in detail.

### Configuration of Light Guide Member

FIGS. 8 and 9 are perspective views of the light guide member 6L, which forms the optical unit 5L, viewed from the front and rear. In other words, FIG. 8 is a perspective view of the light guide member 6L viewed from the side opposite to the viewer's side, and FIG. 9 is a perspective view of the light guide member 6L viewed from the viewer's side.

The light guide members 6R and 6L are disposed in positions according to the right and left eyes of the viewer, respectively, as shown in FIGS. 1 to 5. Each of the light guide members 6R and 6L has a curved shape along the head of the viewer and further has a shape that is a combination of a substantially elliptical shape and a substantially rectangular shape in a front view. Each of the thus configured light guide members 6R and 6L has a main body portion 6A and a light transmissive portion 6B, which are each made of a resin having high light transmittance in a visible light region (cycloolefin polymer, for example) and bonded to each other, as shown in FIGS. 8 and 9.

The main body portion 6A is located on the image-light-incident side of the light guide member 6 (on the side where the corresponding optical unit 5 is present). The main body portion 6A has a plurality of optical surfaces S1 to S5, which will be described later, and has not only a function of causing the image light incident through the projection optical section 52 to be internally reflected and guided to the eye of the viewer and allowing the viewer to visually recognize an image formed by the image light as a virtual image but also a function of transmitting external light to be incident on the eye.

The light transmissive portion 6B is also made of a resin having high light transmittance in a visible light region, as the main body portion 6A is. The light transmissive portion 6B has a function of transmitting external light incident thereon toward the eye of the viewer, whereby the viewer can observe the outside through the light transmissive portion 6B when the viewer moves the line of sight toward the center of the HMD.

An antireflection portion is provided on the thus configured light transmissive portion 6B, specifically, on an end surface 6B3 thereof facing away from the main body portion 6A. The antireflection portion receives the image light having passed through the second surface S2, which will be described later and on which a half-transmissive film is formed. The antireflection portion, which prevents the image light incident thereon from be reflected, prevents the image light from returning to the main body portion 6A as stray light.

The thus configured light guide member 6 has a fitting portion 61, the bonding surface 62, a hole 63, an attachment portion 64, and a positioning portion 65.

The fitting portion 61 is located in an end portion of the main body portion 6A, specifically, an end portion thereof facing the corresponding lens barrel 53 and fit into the opening portion 533 of the lens barrel 53. The fitting portion 61 has a pair of protrusions 611 and 612, which are so disposed on the upper and lower sides that they face each other and protrude toward the lens barrel 53, with the upper protrusion 611 coming into contact with an upper end portion of the inner surface of the opening portion 533 and the lower protrusion 612 coming into contact with a lower end portion of the inner surface.

The bonding surface 62 is a side end surface of the main body portion 6A, specifically, aside end surface thereof facing the lens barrel 53 and is continuous with the fitting portion 61. That is, the bonding surface 62 is an end surface that connects the protrusions 611 and 612 described above to each other. The bonding surface 62 comes into contact with the inner surface of the outer edge (edge facing first cover 41) of the opening portion 533 of the lens barrel lens 53 and bonded to the inner surface with an adhesive.

The hole 63 is formed in a position shifted from the fitting portion 61 toward the center of the HMD. A screw SC1 (see FIG. 6), which fixes the light guide member 6 to the front portion 211 described above, is inserted into the hole 63.

The attachment portion 64 is a portion to which the dustproof cover 7, which will be described later, is attached. The attachment portion 64 has intersection surfaces 641 and 642, which sandwich a second area S42 of the fourth surface S4, which will be described later, from above and below, and intersect the second area S42. In detail, the intersecting surfaces 641 and 642 are disposed in positions that sandwich the second area S42 from above and below (in a direction substantially perpendicular to the direction along the second area S42 viewed from the viewer's side). Extending portions 711 and 712 of the dustproof cover 7, which will be described later, come into contact with the intersecting surfaces 641 and 642, and a sandwiching portion 71, which is formed of the extending portions 711 and 712, sandwiches the intersecting surfaces 641 and 642.

The positioning portion 65 is formed on the upper end surface of the light guide member 6 and formed of a pair of positioning portions that protrude from the upper end surface. Specifically, one of the positioning portions 65 is formed on the main body portion 6A, and the other positioning portion 65 is formed on the light transmissive portion 6B.

The positioning portions 65 are fit in recesses (not shown) formed in the lower end surface of the front portion 211 when the light guide member 6 is fixed to the front portion 211 so that the light guide member 6 is positioned, and the positioning portions 65 prevent rightward and leftward swing motion of the light guide member 6 when the screw SC1 inserted into the hold 63 is screwed into the front portion 211.

### Optical Surfaces of Light Guide Member

FIG. 10 is a lateral cross-sectional view showing the light guide member 6L, in other words, a descriptive diagram for describing the optical surfaces S1 to S5 of the light guide member 6L.

The light guide member 6L has a first surface S1, a second surface S2, a third surface S3, a fourth surface S4, and a fifth surface S5, each of which is an optical surface, as shown in FIG. 10. Among them, the first surface S1 and the fourth surface S4 are surfaces of the light guide member 6L that face the viewer, and the third surface S3 and the fifth surface S5 are surfaces that face away from the viewer. The second surface S2 is not only a surface inclined to the first surface S1 and the third surface S3 but also a boundary surface between the main body portion 6A and the light transmissive portion 6B. Among the surfaces S1 to S5, each of the first surface S1, the third surface S3, and the fourth surface S4 has a hard coat layer formed thereon, and the surfaces S1, S3, and S4 are in contact with an outside air layer.

The surfaces S1 to S5 are not ordinally numbered sequentially from the image light incident side of the light guide member 6L (that is, the side facing the projection optical section 52) but are ordinally numbered sequentially from the light exiting side (that is, the side facing the eyes of the viewer). The reason for this is that it is difficult to evaluate the optical system in a state in which the light outputted from the light modulation portion 512 (image light) travels through the projection optical section 52 and the light guide member 6 and reaches the eye of the viewer as in the case of the actual optical section 3, and that the optical system including the light guide member 6 is hence designed and evaluated on the assumption that light from a light source located at infinity is incident on the light guide member 6 through an aperture located in the position of the eye of the viewer and then focused on the light modulation portion 512 via the projection optical section 52.

Each of the above surfaces S1 to S5 will be described below in detail.

In the following description, a direction Z is a viewing direction in a case where the viewer who wears the HMD 1 faces forward, and directions X and Y are perpendicular to the direction Z and perpendicular to each other. Among the directions, the direction X is oriented from left to right when viewed from the viewer who wears the HMD 1, and the direction Y is oriented from below to above when viewed from the viewer.

The first surface S1 is a free-form surface (continuous free-form surface defined by a single function) formed around a light-exiting-side optical axis AX, which is parallel to the direction Z, and concave toward the viewer. In the light guide member 6, the first surface S1 is located on the viewer's side as described above and formed in a position directly facing the pupil of the viewer. The first surface S1 not only functions as a refractive surface through which the image light having passed through the light guide member 6 exits toward the eye of the viewer but also functions as a total reflection surface that internally totally reflects the image light incident from the third surface S3 toward the second surface S2. That is, an area of the first surface S1, specifically, an area thereof on which the image light is incident corresponds to a fourth reflection area and a light exiting area according to an embodiment of the invention.

A viewer-side surface 6B1 of the light transmissive portion 6B is so formed that it is the same free-form surface as the first surface S1. Therefore, when the light transmissive portion 6B and the main body portion 6A are bonded to each other, the first surface S1 and the surface 6B1 form a single continuous free-form surface.

The second surface S2 is not only a free-form surface formed around an optical axis that is present in a reference plane parallel to the XZ plane (cross section shown in FIG. 10) and inclined to the direction Z but also an end surface of the main body portion 6A, specifically, an end surface thereof facing the other optical section 3. A semi-transmissive layer (semi-reflective layer) is formed in an image light incident area of the second surface S2, and the semi-transmissive layer changes the angle of the image light incident from the first surface S1 and reflects the image light toward the first surface S1. That is, the image light incident area of the second surface S2 corresponds to a fifth reflection area according to an embodiment of the invention. The reflectance at which the semi-transmissive layer reflects the image light incident on the semi-transmissive layer at an angle of incidence within an estimated range is set at a value higher than or equal to 10% but lower than or equal to 50% considering that see-through observation of the outside is readily made.

The third surface S3 is a free-form surface formed around the light-exiting-side optical axis AX described above and concave toward the viewer. The third surface S3 is located on the side facing away from the first surface S1. The third surface S3 has a function of not only changing the angle of the image light incident from the first surface S1 and internally reflecting the image light toward the first surface S1 but also internally totally reflecting the image light incident from the fourth surface S4 toward the first surface S1. That is, an image light incident area of the third surface S3 corresponds to a third reflection area according to an embodiment of the invention. The third surface S3 further has a function of transmitting external light incident from the outside.

A surface 6B2, which is a surface of the light transmissive portion 6B and faces away from the viewer, is so formed that it is the same free-form surface as that of the third surface S3. Therefore, when the light transmissive portion 6B and the main body portion 6A are bonded to each other, the third surface S3 and the surface 6B2 form a single continuous free-form surface.

The fourth surface S4 is a free-form surface convex toward the viewer, and in the light guide member 6, the fourth surface S4 faces the viewer as described above and is closer to the lens barrel 53 than the first surface S1 described above. Specifically, the fourth surface S4 is part of the viewer-side surface of the light guide member 6 formed between the first surface S1 and the bonding surface 62 described above. The thus formed fourth surface S4 is functionally divided into a first area S41, which faces the projection optical section 52 in the lens barrel 53, and a second area S42, which is closer to the first surface S1 than the first area S41.

The first area S41 is an area sandwiched between the protrusions 611 and 612 described above, faces the projection optical section 52, and functions as a light incident area on which the image light from the projection optical section 52 is incident. The first area S41 further functions as a reflection surface that receives part of the image light reflected off the fifth surface S5 and reflects the received light toward the third surface S3.

The second area S42, on which the other part of the image light reflected off the fifth surface S5 is incident, reflects the incident light toward the third surface S3. In the second area S42, the portion on which the other part of the image light is incident is a central area 5421 (see FIG. 9) of the second area S42, and the other part of the image light is not incident on a peripheral area 5422 (hatched area 5422 in FIG. 9). When the dustproof cover 7, which blocks the gap G described above, comes into contact with the area 5422, an air layer can be created between the fourth surface S4 and the dustproof cover 7 and the interior of the light guide member can be sealed without any change in reflection characteristics of the fourth surface S4. The area 5421 described above corresponds to a second reflection area according to an embodiment of the invention.

The fifth surface S5 is, in the light guide member 6, faces away from the first area S41 and coincides with the first area S41 in a front view. The fifth surface S5 is a free-form surface convex toward the viewer, and a total reflection film made, for example, of aluminum is formed on substantially the entire fifth surface S5. The thus configured fifth surface S5, which is inclined to the central axis of the image light incident through the first area S41, reflects part of the image light toward the first area S41 and reflects the other part of the image light toward the second area S42. That is, the fifth surface S5 corresponds to a first reflection area according to an embodiment of the invention.

When the light guide member 6 is fixed to the front portion 211 and the cover member 4 is attached to the temple portion 212, the fifth surface is covered with a front-side end portion of the first cover 41, which forms the cover member 4. The fifth surface S5 is therefore not exposed to the outside.

### Optical Path of Image Light in Light Guide Member

FIG. 11 shows the optical path of the image light in the optical section 3L.

In the optical section 3L, the image light formed by the image formation section 51 is projected toward the light guide member 6L through the projection optical section 52, which has the lenses 521 to 523 arranged in the lens barrel 53, as shown in FIG. 11.

The image light enters the light guide member 6L through the first area S41 of the fourth surface S4 and totally reflected off the fifth surface S5. Part of the image light is incident again on the first area S41 at an angle greater than or equal to the critical angle, and the other part of the image light is incident on the second area S42 at an angle greater than or equal to the critical angle. The thus incident image light is then totally reflected off the first area S41 and the second area S42 and incident on the third surface S3 at an angle greater than or equal to the critical angle.

An in-focus portion FS, where the image light is brought into focus, is set on the optical path of the image light that travels from the fourth surface S4 toward the third surface S3, and an intermediate image is formed in the in-focus portion FS. Therefore, the image light is focused in the in-focus portion FS and then further travels through the light guide member 6L, whereby an image light transmission range and hence an image visually recognized by the viewer is enlarged.

The image light is focused in each of the optical sections 3 in the following three locations: the image formation area of the light modulation portion 512; the in-focus portion FS described above between the fourth surface S4 and the third surface S3 described above; and the position of the eye of the viewer.

The image light incident on the third surface S3 at the angle greater than or equal to the critical angle is totally reflected off the third surface S3 and incident on the first surface S1 at an angle greater than or equal to the critical angle. The image light is totally reflected off the first surface S1, with part of the light incident again on the third surface S3 and the other part of the light incident on the second surface S2.

The light incident again on the third surface S3 is reflected off the third surface S3 and incident on the first surface S1 at an angle smaller than the critical angle. The light incident on the second surface S2 is totally reflected off the second surface S2 and incident on the first surface S1 at an angle smaller than the critical angle. The light incident on the first surface S1 passes therethrough and enters the left eye LE of the viewer. The image light thus reaches the left eye LE of the viewer and is visually recognized as an image.

The description has been made primarily on the configuration of the light guide member 6L for the left eye and the optical path of the image light in the light guide member 6L, and the same holds true for the configuration of the light guide member 6R for the right eye, which has a structure mirror symmetric to the structure of the light guide member 6L, and the optical path of the image light in the light guide member 6R.

### Configuration of Dustproof Cover

Each of the dustproof covers 7 is a cover member made of a synthetic resin (silicon rubber, for example) that is elastic and transmits light, and the dustproof covers 7 are detachably attached to the right and left light guide members 6R, 6L and the second covers 42 of the HMD 1 as shown in FIG. 2.

Each of the dustproof covers 7 (reference character 7R denotes the dustproof cover disposed on the right of the viewer, and reference character 7L denotes the dustproof cover disposed on the left of the viewer) is a blocking member that blocks the gap G between the extending portion 534, which is an inner end portion of the lens barrel 53, and the fourth surface S4 to prevent dust (including dirt and other adherent particles) from entering the lens barrel 53 through the gap G. That is, when attached to the light guide members 6R and 6L and the second covers 42, the dustproof covers 7 each form a blocking section or a cover section that blocks the gap G. The thus configured dustproof covers 7R and 7L are formed in mirror symmetry to each other.

FIG. 12 is a perspective view showing the light guide member 6L to which the dustproof cover 7L is attached.

The dustproof cover 7L has a major axis in the rightward/leftward direction (direction X described above) when viewed from the viewer's side and has a semielliptical shape having an arcuate right portion, as shown in FIG. 12. The dustproof cover 7L is so attached to the light guide member 6L that the dustproof cover 7L primarily covers part of the fourth surface S4 described above, specifically, the second area S42, which is not covered with the lens barrel 53.

When the auxiliary frame 25 described above is provided, the end portion 2521 of the rim 252L, which forms the auxiliary frame 25, comes into contact with the viewer-side surface 7A of the dustproof cover 7L, as shown in FIG. 3, and the end portion 2521 will not come into contact with the light guide member 6L to scratch or otherwise damage the light guide member 6L.

Further, an end surface of the dustproof cover 7L, specifically, an end surface 7C thereof facing the lens barrel 53 comes into contact with the inner surface of the recess 421 formed in the second cover 42 described above.

FIG. 13 is a perspective view of the dustproof cover 7L viewed from the side where the light guide member 6L is present.

The dustproof cover 7L has a laterally-facing U-like shape having the bottom surface 7A in a cross-sectional view along the upward/downward direction, as shown in FIG. 13. The dustproof cover 7L has the sandwiching portion 71, a recess 72, and a contact portion 73.

The sandwiching portion 71 sandwiches the attachment portion 64 of the light guide member 6L. The sandwiching portion 71 has the pair of extending portions 711 and 712, which extend from the upper and lower ends of the dustproof cover 7L toward the side facing away from the surface 7A, that is, the side where the light guide member 6L is present. The dimension between the extending portions 711 and 712 (the dimension between the lower surface of the extending portion 711 and the upper surface of the extending portion 712) is set to be slightly smaller than the dimension in the same direction between the intersecting surfaces 641 and 642. Therefore, in a state in which the extending portion 711 is in contact with the upper intersecting surface 641 and the extending portion 712 is in contact with the lower intersecting surface 642, an elastic force of the dustproof cover 7L allows the extending portions 711 and 712 to sandwich the attachment portion 64.

The recess 72 and the contact portion 73 are formed in a surface of the dustproof cover 7L, specifically, a surface 7B thereof facing away from the surface 7A (surface on the side where the light guide member 6L is present).

The recess 72 is formed in a substantially central portion of the surface 7B. The position where the recess 72 is formed corresponds to the image light incident area 5421 of the second area S42 of the light guide member 6L to which the dustproof cover 7L is attached.

The contact portion 73 has a laterally-facing, substantially U-like shape formed around the recess 72 and protrudes with respect to the recess 72 toward the light guide member 6L. The position where the contact portion 73 is formed corresponds to the peripheral area 5422 of the second area S42 (part of the second area S42 on which no image light is incident).

FIG. 14 is a lateral cross-sectional view showing the optical section 3L.

When the dustproof cover 7L described above is attached, the sandwiching portion 71 sandwiches the attachment portion 64 as shown in FIG. 12, and an end portion of the dustproof cover 7L, specifically, an end portion facing the end surface 7C fits into the recess 421 and the end surface 7C comes into intimate contact with the inner surface of the recess 421 as shown in FIG. 2. In this state, the dustproof cover 7L blocks the gap G between the fourth surface S4 and the extending portion 534 of the lens barrel 53, as shown in FIG. 14. Further, in this state, since the contact portion 73 of the dustproof cover 7L comes into contact with the area S422, the recess 72 and the area 5421 do not come into contact with each other, and an air layer AL is created between the area 5421 and the dustproof cover 7L. Reflection characteristics of the area 5421 will therefore not change.

The portion of the dustproof cover 7L that is fit into the recess 421 has a dimension slightly greater than the dimension of the recess 421 in the same direction. Therefore, when the dustproof cover 7L is fit into the recess 421, the dustproof cover 7L exerts an outward elastic force on the inner surface of the recess 421. The dustproof cover 7L is therefore stably positioned in the recess 421.

On the other hand, in the optical section 3R as well, the image light formed by the image formation section 51 is incident via the projection optical section 52 and the light guide member 6R on the right eye of the viewer and visually recognized as a virtual image. The dustproof cover 7R, which has a structure mirror symmetric to the structure of the dustproof cover 7L, is attached to the light guide member 6R and the lens barrel 53, whereby the gap G between the light guide member 6R and the lens barrel 53, which forms the optical section 3R, is blocked.

The HMD 1 according to the present embodiment described above provides the following advantageous effects.

In the optical section 3L, the dustproof cover 7L attached to the light guide member 6L and the second cover 42 blocks the gap G created between the light guide member 6L and the lens barrel 53. The thus attached dustproof cover 7L prevents dust from entering the lens barrel 53 through the gap G and hence prevents dust from adhering to the projection optical section 52 accommodated in the lens barrel 53, whereby an image visually recognized based on image light formed by the image formation section 51 will not be degraded and maintenance operation of removing dust from the interior of the lens barrel 53 can be omitted. The same holds true for the optical section 3R.

In the optical section 3L, the image light projected by the projection optical section 52 enters the light guide member 6L through the first area S41 and is reflected off the fifth surface S5 inclined to the central axis of the image light. Part of the image light reflected off the fifth surface S5 is then incident on the area 5421 in the second area S42, is further reflected off the area 5421, and travels through the light guide member 6L. When dust having adhered to the area 5421 is present, a shadow of the dust is possibly visually recognized by the viewer. To avoid the situation, covering the area 5421 with the dustproof cover 7L prevents dust from adhering to the area S421, whereby no shadow of dust is visually recognized.

Further, since the dustproof cover 7L is so attached that the air layer AL is created between the dustproof cover 7L and the area 5421, the dustproof cover 7L will not change reflection characteristics of the area 5421. The image light having entered the light guide member 6L is therefore allowed to be reflected appropriately and then guided to the eye of the viewer.

The same holds true for the optical section 3R.

In the light guide member 6L, the in-focus portion FS, where the image light is brought into focus, is set between the fourth surface S4 and the third surface S3, and the image light having passed through the in-focus portion FS travels through the light guide member 6L with the transmission range increasing. The image light is then incident on the eye of the viewer via the third surface S3, the second surface S2, and the first surface S1, whereby the image light can travel along a long optical path. An image visually recognized by the viewer can therefore be enlarged.

On the other hand, since the in-focus portion FS described above is set between the fourth surface S4 and the third surface S3, any dust having adhered to the area 5421 of the fourth surface S4 is likely to not only cause the viewer to visually recognize a shadow of the dust but also change reflection characteristics of the area 5421. To avoid the situation, providing the dustproof cover 7L described above prevents dust from adhering to the area 5421 and hence reliably prevents a shadow of dust from being visually recognized but allows the image light incident on the area 5421 to be appropriately reflected.

The same holds true for the optical section 3R.

In the optical section 3L, in the state in which the contact portion 73 is in contact with the area 5422, which is located around the area 5421 of the fourth surface S4 and on which no image light is incident, the recess 72 creates the air layer AL between the dustproof cover 7L and the area 5421. The thus attached dustproof cover 7L reliably prevents reflection characteristics of the area 5421 from changing. Therefore, the image light incident on the area 5421 can be appropriately reflected, and hence the image light can be reliably guided to the eye of the viewer. The same holds true for the optical section 3R.

In the optical section 3L, the light guide member 6L has the pair of intersecting surfaces 641 and 642, which are located in positions that sandwich the second area S42, extend along a direction (direction Y) substantially perpendicular to the direction oriented from the first area S41 toward the second area S42 when viewed from the viewer's side (that is, direction X, which is oriented from left to right), and intersect the second area S42. Further, the dustproof cover 7L has the sandwiching portion 71, which sandwiches the light guide member 6L when the sandwiching portion 71 comes into contact with the pair of intersecting surfaces 641 and 642. The thus configured sandwiching portion 71, which sandwiches the light guide member 6L, allows the dustproof cover 7L to be attached to the light guide member 6L in a stable manner with the dustproof cover 7L not in contact with the area 5421, on which image light is incident. The same holds true for the optical section 3R.

According to the optical section 3L, the auxiliary frame 25, which includes the lenses 251R and 251L for vision correction, can be attached to the front portion 211 in a position on the viewer's side, whereby even a viewer having poor vision can visually recognize an image in a preferable manner.

Further, the thus configured auxiliary frame 25 has the pair of rims 252R and 252L and the opposite ends 2521 thereof come into contact with the viewer-side surfaces 7A of the dustproof covers 7R and 7L. The configuration prevents the rims 252R and 252L from coming into contact with the light guide members 6R and 6L, which will therefore not be damaged.

Since each of the dustproof covers 7 has elasticity, the contact portion 73 can be in intimate contact not only with the area 5422 but also with the inner surface of the recess 421 of the second cover 42. The gap G can therefore be sealed from the outside, and the sealed gap G reliably prevents dust from entering the HMD.

Further, since the dustproof covers 7 can be detachably attached to the light guide members 6, each of the dustproof covers 7 can be exchanged when dust adheres to the dustproof cover 7 or the dustproof cover 7 otherwise becomes dirty. The HMD 1 can therefore be readily maintained clean.

When the light guide member 6L does not have a shape curved along the head of the viewer but has, for example, a flat-plate-like shape, the center of gravity of the light guide member 6L tends to be separate from the viewer, resulting in discomfort of the viewer who wears the HMD. To avoid the situation, the light guide member 6L has a shape curved along the head of the viewer, whereby the center of gravity of the light guide member 6L approaches the viewer, and hence the viewer can comfortably and stably wear the HMD 1.

On the other hand, when the light guide member 6L has a curved shape, it is difficult to control the gap G between the light guide member 6L and the lens barrel 53, and the size of the gap G may, for example, increase, encouraging dust to enter the gap G. Even in such a case, the gap G blocked by the dustproof cover 7L prevents dust from entering the HMD, whereby the advantageous effects described above provided by the curved shape of the light guide member 6L can be preferably provided.

The same holds true for the optical section 3R, which includes the light guide member 6R and the dustproof cover 7R.

### Variations of Embodiment

The invention is not limited to the embodiment described above, and variations, improvements, and other modifications to the extent that they achieve the advantage of the invention fall within the scope of the invention.

In the embodiment described above, the light guide member 6L is so configured that part of the image light reflected off the third surface S3 is reflected off the first surface S1, then reflected off the second surface S2, and guided through the first surface S1 to the eye of the viewer, but the invention is not necessarily configured in this way. That is, the optical surfaces of the light guide member can be changed as appropriate. For example, the image light reflected off the third surface S3 may be directed to the eye of the viewer. In this case, for example, the angle of the first surface S1 with respect to the light-exiting-side optical axis AX described above may be so changed that the image light incident from the third surface S3 is incident on the first surface S1 at an angle smaller than the critical angle. In other words, the first surface S1 may not serve as both the total reflection surface and the light exiting surface. The same holds true for the light guide member 6R.

In the embodiment described above, the air layer AL is created between the light guide member 6L and the dustproof cover 7L, but the invention is not necessarily configured in this way. For example, the light guide member 6L and the dustproof cover 7L may be in contact with each other via a portion made of a material having a refractive index smaller than that of the light guide member 6L. In this case, in the configuration described above, the light guide member 6L may be so configured that the image light is incident on the fourth surface S4 at an angle greater or equal to the critical angle associated with the fourth surface S4. Further, the light guide member 6L and the dustproof cover 7L may be integrated with each other by using an adhesive made of the material described above. The same holds true for the light guide member 6R and the dustproof cover 7R.

In the embodiment described above, each of the dustproof covers 7 can be detachably attached to the corresponding light guide member 6 and second cover 42, but the invention is not necessarily configured in this way. For example, each of the dustproof covers 7 may be bonded to the fourth surface S4, specifically, the area 5422 thereof with the air layer AL created between the dustproof cover 7 and the area 5421. Further, each of the dustproof covers 7 is not necessarily attached to the second cover 42 but may be attached to a side surface of the lens barrel 53. To this end, the side surface may be exposed through the recess 421 and the end surface 7C of the dustproof cover 7 may be allowed to come into intimate contact with the side surface. Moreover, each of the dustproof covers 7 may be integrated with at least one of the corresponding light guide member 6, second cover 42, and lens barrel 53. That is, the blocking section according to an embodiment of the invention may be detachably attached to or integrated with any member as long as the blocking section has a function of blocking the gap G between the lens barrel 53 and the light guide member 6.

In the embodiment described above, in the light guide member 6L, the in-focus portion FS, where the image light is brought into focus, is set between the fourth surface S4 and the third surface S3, but the invention is not necessarily configured in this way. That is, the in-focus portion FS may be set in any other position in the light guide member 6L, or the in-focus portion FS may not be set in the light guide member 6L. The same holds true for the light guide member 6R.

In the embodiment described above, the dustproof cover 7L has the sandwiching portion 71, which comes into contact with the intersecting surfaces 641 and 642, which intersect the second area S42 of the fourth surface S4, to sandwich the attachment portion 64, but the invention is not necessarily configured in this way. That is, the dustproof cover 7L may be attached to the light guide member 6L in any other suitable way. The same holds true for the dustproof cover 7R.

In the embodiment described above, the dustproof covers 7 are made of silicon rubber as an elastic material, but the invention is not necessarily configured in this way. That is, the dustproof covers 7 may be made of any other suitable material, for example, PC (polycarbonate), PMMA (polymethyl methacrylate), or any other rigid resin. Further, the dustproof covers 7, which are configured to transmit light in the embodiment described above, may instead be configured to block light or be colored with a predetermined color.

In the embodiment described above, the auxiliary frame 25 is provided with the lenses 251R and 251L for vision correction, but the invention is not necessarily configured in this way. That is, each of the lenses 251R and 251L may be replaced with an optical part having other optical characteristics. As an example of the optical part, a filter that prevents transmission of color light of a predetermined wavelength may be employed. In this case, the color tone of a visually recognized image can be corrected. As another example of the optical part, a filter that prevents transmission of blue light, which is believed to have relatively strong energy, may be employed. In this case, an effect of blue light on the eyes of the viewer can be reduced.

Further, the auxiliary frame 25 is configured to have the pair of lenses 251R and 251L, the pair of rims 252R and 252L, and the bridge 253, but the invention is not necessarily configured in this way. The auxiliary frame 25 may instead be configured to have one lens and one rim.

In the embodiment described above, the light guide members 6R and 6L have a shape curved along the shape of the head of the viewer, but the invention is not necessarily configured in this way. For example, light guide members having a flat-plate-like shape can be employed. Further, each of the surfaces S1 to S5 may not be a free-form surface, and the shape of the light guide members can be changed as appropriate. Further, the first area S41 and the second area S42 of the fourth surface S4 may be free-form surfaces different from each other.

In the embodiment described above, the second surface S2 is configured to be a half-silvered mirror on which a semi-transmissive layer is formed, but the invention is not necessarily configured in this way. That is, the second surface S2 may be formed of a polarizing beam splitter, a hologram or any other diffraction grating, or any other suitable optical component.

In the embodiment described above, the HMD 1 including the optical section 3L, which causes image light to be incident on the left eye of the viewer, and the optical section 3R, which causes image light to be incident on the right eye of the viewer, is presented by way of example of the virtual image display apparatus, but the invention is not necessarily configured in this way. That is, the HMD may instead be configured to include one of the optical sections 3L and 3R. Further, the light guide members 6 have a shape the follows the head of the viewer in the rightward/leftward direction, but the light guide members 6 are not necessarily configured in this way. For example, the light guide members 6 may instead be so shaped that they follow the head of the viewer in the upward/downward direction. In this case, the optical units 5 are not disposed in the positions of the temples of the viewer but may be disposed in the vicinity of the top of the head of the viewer or in the vicinity of the jaw thereof.

In the embodiment described above, each of the image formation sections 51 is configured to include the light source portion 511 and the light modulation portion 512 having a transmissive liquid crystal panel, but the invention is not necessarily configured in this way. For example, the transmissive liquid crystal panel may be replaced with a reflective liquid crystal panel. Further, the liquid crystal panel may be replaced with a micromirror-based device, or a light modulation portion based on a non-liquid crystal technology. Moreover, the light source portion 511 and the light modulation portion 512 may be replaced with a panel formed of a self-luminous light emitting device based, for example, on organic EL (electroluminescence), plasma, or any other technology. In addition, a retina projection HMD (laser retinal projection HMD, for example) may be configured by employing an image formation section that scans the retina with image light via the projection optical section 52 and the light guide member 6 to allow the viewer to visually recognize an image.

Further, the HMD 1 does not necessarily include the image formation sections 51, but image light formed by an external apparatus connected to the HMD may be introduced through an optical fiber or any other light guide, and the image light may be allowed to be incident on the projection optical sections.

In the embodiment described above, the see-through-type HMD 1 is presented by way of example of the virtual image display apparatus, but the invention is not necessarily configured in this way. That is, the invention is also applicable to a non-transmissive HMD that does not allow observation of the outside and a video-see-through-type HMD that displays images captured with an imaging device that captures images of the outside.

The invention can be used with a virtual image display apparatus and can, for example, be preferably used with an HMD worn around the head of a viewer.

The entire disclosure of Japanese Patent Application No. 2013-050109, filed Mar. 13, 2013 is expressly incorporated by reference herein.

What is claimed is:

1. A virtual image display apparatus that is worn around a head of a viewer and displays a virtual image, the apparatus comprising:
a projection optical section that projects light that forms an image;
a lens barrel that accommodates the projection optical section;
a light-transmissive light guide member that causes the light from the projection optical section to be internally reflected and guided to an eye of the viewer to allow the viewer to visually recognize the image as a virtual image; and
a blocking section that blocks a gap created between the light guide member and the lens barrel.

2. The virtual image display apparatus according to claim 1,
wherein the light guide member has
a light incident area on which the light from the projection optical section is incident,
a first reflection area that is inclined to a central axis of the light incident on the light incident area and reflects the incident light, and
a second reflection area on which the light reflected off the first reflection area is incident and which reflects the incident light, and
the blocking section is so disposed that an air layer is created between the blocking section and the second reflection area and the second reflection area is covered.

3. The virtual image display apparatus according to claim 2,
wherein the light guide member further has
a third reflection area that faces the second reflection area and reflects the light reflected off the second reflection area,
a fourth reflection area that faces the third reflection area and reflects the light reflected off the third reflection area,
a fifth reflection area that reflects the light incident from the fourth reflection area toward the eye of the viewer, and
a light exiting area through which the light reflected off the fifth reflection area exits toward the eye of the viewer, and
an in-focus portion where the light that forms the image is brought into focus is set in the light guide member between the second reflection area and the third reflection area.

4. The virtual image display apparatus according to claim 2,
wherein the blocking section has
a contact portion that comes into contact with a portion around the second reflection area in the light guide member, and
a recess that forms the air layer between the blocking section and the second reflection area when the contact portion comes into contact with the portion around the second reflection area.

5. The virtual image display apparatus according to claim 2,
wherein the light guide member has a pair of intersecting surfaces that intersect the second reflection area, the intersecting surfaces located in positions that sandwich the second reflection area in a direction substantially perpendicular to a direction along the second reflection area when viewed from the viewer's side, and
the blocking section has a sandwiching portion that comes into contact with the pair of intersecting surfaces to sandwich the light guide member.

6. The virtual image display apparatus according to claim 1,
further comprising a first frame that supports the lens barrel and the light guide member; and
a second frame that is attached to the first frame and located on the viewer's side with respect to the light guide member,
wherein the second frame includes
an optical part that is provided in accordance with the eye of the viewer and has a predetermined optical characteristic, and
a rim that holds the optical part, and
the rim comes into contact with the blocking section.

7. The virtual image display apparatus according to claim 1,
wherein the blocking section has elasticity and is detachably attached to the light guide member.

8. The virtual image display apparatus according to claim 1,
wherein the light guide member has a shape curved along the head of the viewer.
